(19) United States
(12) Patent Application Publication
(10) Pub. No.: US 2020/0182179 A1
(43) Pub. Date: Jun. 11, 2020

(54) THREE-WAY CATALYST OXYGEN STORAGE MODEL

(71) Applicant: GM GLOBAL TECHNOLOGY OPERATIONS LLC, Detroit, MI (US)

(72) Inventors: Gongshin Qi, Troy, MI (US); Sergio A. Mendoza Galvis, Natick, MA (US); Se H. Oh, Troy, MI (US); Min Sun, Troy, MI (US); Wei Li, Troy, MI (US); Patricia A. Mulawa, Clinton Township, MI (US)

(21) Appl. No.: 16/216,293

(22) Filed: Dec. 11, 2018

(51) Int. Cl. F02D 41/02; F01N 3/10; F01N 9/00; F02D 41/14

(52) U.S. Cl. CPC F02D 41/0295; F01N 3/101; F01N 9/00; F02D 41/1441; F01N 2900/1624; F02D 2200/0814; F02D 2200/0816; F01N 2560/025; F02D 41/1454

(57) ABSTRACT

Technical methods described herein include an emissions control system for treating exhaust gas from an internal combustion engine in a motor vehicle. The emissions control system includes a three-reaction oxygen storage model. The system further includes a three-way catalyst and a controller that controls an oxygen storage level for the three-way catalyst. The controller determines a first reaction rate representing a net rate of cerium oxidation by oxygen, a second reaction rate representing a net rate of cerium reduction by carbon monoxide, and a third reaction rate representing a net rate of cerium reduction by hydrogen. The controller further determines the oxygen storage level based on the first reaction rate, the second reaction rate, and the third reaction rate.

### INTRODUCTION

The present disclosure relates to exhaust emission control systems for internal combustion engines and, more particularly, to the development and implementation of an improved three-way catalyst (TWC) oxygen storage model.

Exhaust gas emitted from an internal combustion engine is a heterogeneous mixture that contains gaseous emissions such as carbon monoxide (“CO”), unburned hydrocarbons (“HC”) and oxides of nitrogen (“NOx”). Many of these emission components are highly regulated. Catalyst components, typically disposed on catalyst supports or substrates, are provided in engine exhaust systems as part of an aftertreatment system to convert certain, or all, of these exhaust constituents into non-regulated compounds.

An exhaust gas treatment system typically includes one or more catalyst-based treatment devices, such as a three-way catalyst (TWC). The objective of a TWC is to convert the primary pollutants from the engine into carbon dioxide, water, and nitrogen. For a TWC, the highest conversion efficiency is achieved when the air-to-fuel ratio (AFR) of the gas passing through the TWC is as close to stoichiometrically balanced as possible (i.e., under conditions where the amount of oxidants is equal to that of reducing agents). In other words, controlling the AFR to maintain stoichiometry allows for the TWC to most efficiently convert the exhaust pollutants to harmless compounds.

TWCs contain one or more materials which can store and release oxygen. The use of an oxygen storage system compensates for any deviation of the AFR from stoichiometry through its capability of storing and releasing oxygen during lean (excess of oxygen) and rich (excess of fuel) conditions, respectively. Reducible oxides, such as ceria-zirconia are frequently used as an oxygen storage component.

### SUMMARY

Technical methods described herein include an emissions control system for treating exhaust gas from an internal combustion engine in a motor vehicle. The emissions control system includes a three-reaction oxygen storage model. The system further includes a three-way catalyst and a controller that controls an oxygen storage level for the three-way catalyst. The controller determines a first reaction rate associated with a net rate of cerium oxidation by oxygen, a second reaction rate associated with a net rate of cerium reduction by carbon monoxide, and a third reaction rate associated with a net rate of cerium reduction by hydrogen. The controller further determines the oxygen storage level based on the first reaction rate, the second reaction rate, and the third reaction rate.

In addition to one or more of the features described above, in some embodiments the controller is further configured to adjust an operation of the internal combustion engine in response to the determined oxygen storage level (OSL). In some embodiments, adjusting the operation of the internal combustion engine comprises adjusting a fuel injection timing, an injected amount of air-fuel mixture, an engine speed, or an air intake. In some embodiments, an air to fuel (A/F) ratio sensor is positioned upstream of the three-way catalyst and the controller is further configured to receive a measured air-to-fuel ratio from the sensor. In some embodiments, the three-reaction oxygen storage model comprises a first reaction according to the formula:

O₂+2 Ce₂O₃ [symbol] 2 Ce₂O₄.

In some embodiments, the three-reaction oxygen storage model comprises a second reaction according to the formula:

CO+Ce2O4 [symbol] CO2+Ce2O.

In some embodiments, the three-reaction oxygen storage model comprises a third reaction according to the formula:

H₂+Ce₂O₄ [symbol] H₂O+Ce₂O₃.

In some embodiments, the oxygen storage level Φ is determined according to the formula:

$$\frac{\partial Φ}{\partial t} = \frac{1}{OSC} \cdot ( 2 {r}_{1} - {r}_{2} - {r}_{3} ) .$$

In some embodiments, the emissions control system further includes a wide range air/fuel (WRAF) sensor operably coupled to the controller. The controller can be further configured to receive a measured air-to-fuel ratio from the WRAF sensor. In some embodiments, the controller is further configured to adjust the measured air-to-fuel ratio based on a hydrogen concentration.

In another exemplary embodiment, a method for treating exhaust gas from an internal combustion engine in a motor vehicle is provided. The method utilizes an oxygen storage model. The oxygen storage model includes a first reaction associated with a net rate of cerium oxidation by oxygen, a second reaction associated with a net rate of cerium reduction by carbon monoxide, and a third reaction associated with a net rate of cerium reduction by hydrogen. The method further includes determining a first reaction rate associated with the first reaction, determining a second reaction rate associated with the second reaction, and determining a third reaction rate associated with the third reaction. The method further includes determining an oxygen storage level of the three-way catalyst based on the first reaction rate, the second reaction rate, and the third reaction rate.

In addition to one or more of the features described above, or as an alternative, further embodiments of the method may include adjusting an operation of the internal combustion engine in response to the determined oxygen storage level. In some embodiments, adjusting the operation of the internal combustion engine comprises adjusting a fuel injection timing, an injected amount of air-fuel mixture, an engine speed, or an air intake. The method may include receiving a measured air-to-fuel ratio from a WRAF sensor positioned upstream of the three-way catalyst. In some embodiments, the three-reaction oxygen storage model comprises a first reaction according to the formula:

O₂+2 Ce₂O₃ [symbol] 2 Ce₂O₄.

In some embodiments, the three-reaction oxygen storage model comprises a second reaction according to the formula:

CO+Ce₂O₄ [symbol] CO₂+Ce₂O.

In some embodiments, the three-reaction oxygen storage model comprises a third reaction according to the formula:

H₂+Ce₂O₄ [symbol] H₂O+Ce₂O₃.

In some embodiments, the oxygen storage level Φ is determined according to the formula:

$$\frac{\partial Φ}{\partial t} = \frac{1}{OSC} \cdot ( 2 {r}_{1} - {r}_{2} - {r}_{3} ) .$$

In some embodiments, the method further includes receiving a measured air-to-fuel ratio from a WRAF sensor and adjusting the measured air-to-fuel ratio based on a hydrogen concentration.

In yet another exemplary embodiment, a computer program product includes a memory storage device having computer executable instructions stored therein, and the computer executable instructions, when executed by a processor, cause the processor to execute a computer-implemented method for treating exhaust gas from an internal combustion engine in a motor vehicle. The method utilizes an oxygen storage model. The oxygen storage model includes a first reaction associated with a net rate of cerium oxidation by oxygen, a second reaction associated with a net rate of cerium reduction by carbon monoxide, and a third reaction associated with a net rate of cerium reduction by hydrogen. The method further includes determining a first reaction rate associated with the first reaction, a second reaction rate associated with the second reaction, and a third reaction rate associated with the third reaction. The method further includes determining an oxygen storage level of the three-way catalyst based on the first reaction rate, the second reaction rate, and the third reaction rate.

In addition to one or more of the features described above, or as an alternative, further embodiments may include adjusting an operation of the internal combustion engine in response to the determined oxygen storage level. Adjusting the operation of the internal combustion engine may include adjusting a fuel injection timing, an injected amount of air-fuel mixture, an engine speed, or an air intake.

In addition to one or more of the features described above, or as an alternative, further embodiments may include receiving a measured air-to-fuel ratio from a WRAF oxygen sensor and adjusting the measured air-to-fuel ratio based on a hydrogen concentration.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 depicts a motor vehicle including an internal combustion engine and an emission control system according to one or more embodiments;

FIG. 2 illustrates example components of an exhaust system and an emissions control system according to one or more embodiments;

FIG. 3 depicts an exemplary carbon monoxide to hydrogen concentration ratio curve according to one or more embodiments;

FIG. 4 depicts an exemplary hydrogen-induced oxygen sensor reading variation curve according to one or more embodiments; and

FIG. 5 illustrates a flowchart of an illustrative method according to one or more embodiments.

### DETAILED DESCRIPTION

The following description is merely illustrative in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory module that executes one or more software or firmware programs, a combinational logic circuit, and/or other suitable components that provide the described functionality.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include an indirect “connection” and a direct “connection”.

As shown and described herein, various features of the disclosure will be presented. Although similar reference numbers may be used in a generic sense, various embodiments will be described and various features may include changes, alterations, modifications, etc. as will be appreciated by those of skill in the art, whether explicitly described or otherwise would be appreciated by those of skill in the art.

Described herein is a novel exhaust aftertreatment system architecture that includes an improved three-way catalyst (TWC) oxygen storage model. An exhaust treatment system can include a TWC oxygen storage model to better ensure that a stoichiometrically balanced gas reaches the TWC under actual vehicle operating conditions. This in turn improves the conversion efficiency of the TWC, thereby reducing emissions.

In the case of conventional gasoline engine fuels, stoichiometric conditions are present when the air-to-fuel ratio has a value of approximately 14.6. For ethanol fuels, the stoichiometric air-to-fuel ratio is approximately 9. The air-to-fuel ratio is the ratio of the mass of air to the mass of fuel in the mixture inside the internal combustion engine during ignition. In other words, the air-to-fuel ratio states how many kilograms of air are required for complete combustion of one kilogram of fuel.

In many applications, the air-to-fuel ratio is rewritten in normalized form (sometimes denoted as λ) by taking the ratio of the air-to-fuel ratio present in the mixture at the time of combustion to the stoichiometric air-to-fuel ratio (i.e., λ=AFR_{actual}/AFR_{stoichiometric}). The normalized air-to-fuel ratio λ is often measured at the exhaust gas. Substoichiometric exhaust gas compositions with λ<1 are called “rich” and superstoichiometric exhaust gas compositions with λ>1 are called “lean.” The normalized air-to-fuel ratio λ can be calculated from the exhaust gas concentrations according to the following formula:

$$λ = \frac{2 \cdot ( [ {O}_{2} ] + [ {CO}_{2} ] ) + [ CO ]}{2 \cdot ( [ CO ] + [ {CO}_{2} ] )}$$

The oxygen storage level (OSL) of an oxygen storage system is a measure of its ability to moderate the negative effects of rich and lean oscillations in the exhaust gas composition. The oxygen storage capacity (OSC) of an oxygen storage system changes over time in response to rich and lean real-world transient operating conditions. For example, the OSL can decrease following prolonged fuel rich periods, due to the depletion of oxygen stored in the catalyst. Similarly, the OSL can increase following prolonged lean periods, as the oxygen storage components are filled with stored oxygen. An accurate estimate of the current OSL of an oxygen storage system, together with the catalyst temperature, can be used to prevent fueling overshoots. Fueling overshoots reduce fuel economy and increase emission levels.

Conventional oxygen storage systems are modeled using a two-reaction oxygen storage model. For example, in a cerium-based oxygen storage system, cerium oxide is oxidized by oxygen and reduced by carbon monoxide according to the following reversible reactions (R1, R2):

O₂+2 Ce₂O₃ [symbol] 2 Ce₂O₄ (R1)

CO+Ce₂O₄ [symbol] CO₂+Ce₂O₃ (R²)

Reaction 1 (R1) represents the reversible oxygen storage rate when reduced cerium reacts with oxygen (O₂), while reaction 2 (R2) represents the reversible oxygen release rate when the oxidized cerium reacts with carbon monoxide (CO).

The reduced cerium oxide (Ce₂O₃) concentration and the oxidized cerium oxide (Ce₂O₄) concentration taken together contribute to the total OSC of the oxygen storage system, according to the formula:

[Ce₂O₃]+[Ce₂O₄]=OSC (I)

The net reaction rates (r₁, r₂) due to the forward reaction rate (kᵢ^{f}) and the backward reaction rate (kᵢ^{b}) shown in the above reactions are given by

r₁=k₁^{f}·[Ce₂O₃]²·[O₂]−k₁^{b}·[Ce₂O₄]²·c₀

r₂=k₂^{f}·[Ce₂O₄]·[CO]−k₂^{b}·[Ce₂O₃]·[CO₂]

Where c₀ is the total exhaust gas concentration, equal to P/(R·T_{g}), where P is the exhaust gas pressure, R is the universal gas constant (R is approximately 8.314 J/kg·K), and T_{g} is the exhaust gas temperature. The symbol [X] is used to represent the chemical species concentrations for X=O₂, CO, CO₂, Ce₂O₃, and Ce₂O₄.

The forward reaction rate constants k₁^{f} and k₂^{f} depend on the catalyst temperature. The backward reaction rate constants k₁^{b} and k₂^{b} are dependent on their respective forward reaction constants along with the chemical equilibrium constant, which is a function of the Gibbs energy difference term.

Using these reaction rates, the oxygen storage level (OSL, often denoted by Φ) for the conventional two-reaction oxygen storage models can be calculated according to the formula:

$$\frac{\partial Φ}{\partial t} = \frac{1}{OSC} \cdot ( 2 \cdot {r}_{1} - {r}_{2} )$$

The oxygen storage level Φ represents the fraction of the oxidized cerium (Ce₂O₄) present in the catalyst. In some implementations, the oxygen storage level is known as the state of oxygen (SOX) and is normalized with respect to the OSC (i.e., 0<Φ<1). In these implementations, the oxygen storage level can be referred to as the fractional oxygen storage capacity.

Conventional oxygen storage systems modeled using two-reaction oxygen storage models have been somewhat successful. Unfortunately, these systems only consider the effects of the concentrations of carbon monoxide, carbon dioxide, and oxygen on cerium oxidation state changes, while ignoring the contributions that other factors, such as hydrogen and water, may have on cerium reduction and oxidation, respectively. Hydrogen, is a more powerful reductant than carbon monoxide. Also, water is more effective than carbon dioxide in re-oxidizing cerium. Consequently, the accuracy of conventional two-reaction oxygen storage models in the actual exhaust environment can be limited. As a result, the maximum potential improvement to the overall fuel economy and to emission reductions afforded by a TWC system may not be realized.

To robustly meet ultra-low emission regulations, the improved exhaust treatment system described herein leverages a three-reaction oxygen storage model. In addition to the two reactions described previously herein (R1, representing the net rate of cerium oxidation by oxygen; and R2, representing the net rate of cerium reduction by carbon monoxide), a third reaction is introduced to describe the reduction of cerium by hydrogen as well as the re-oxidation of the reduced cerium by water, according to the following reversible reaction (R3):

H₂+Ce₂O₄ [symbol] H₂O+Ce₂O₃ (R3)

In other words, R3 represents the net rate of cerium reduction determined by reduction of oxidized cerium oxide (Ce₂O₄) by hydrogen and re-oxidation of the reduced cerium oxide (Ce₂O₃) by water. This three-reaction oxygen storage model enables a more accurate OSC estimation in the presence of hydrogen and excess water in the exhaust and can improve the oxygen sensor reading accuracy. The improved OSC estimations are provided to an exhaust treatment system controller to optimize diagnostic fueling strategies and prevent fueling overshoots, improving emission performance as well as the overall fuel economy.

The net reaction rates (r₁, r₂, r₃) for the three-reaction oxygen storage model, rewritten in terms of the oxygen storage level Φ, are expressed according to the following equations:

r₁=k₁^{f}OSC²(1−Φ)²[O₂]−k₁^{b}OSC²Φ²C₀

r₂=k₂^{f}OSCΦ[CO]−k₂^{b}OSC(1−Φ)[CO₂]

r₃=k₃^{f}OSCΦ[H₂]−k₃^{b}OSC(1−Φ)[H₂O]

Using these reaction rates, the oxygen storage level Φ can be calculated according to the formula:

$$\frac{\partial Φ}{\partial t} = \frac{1}{OSC} \cdot ( 2 {r}_{1} - {r}_{2} - {r}_{3} )$$

The oxygen storage level Φ represents a measure of the availability of the stored oxygen present in the catalyst. In some implementations, the oxygen storage level is known as the state of oxygen (SOX) and is normalized with respect to the OSC (i.e., 0<Φ<1). In these implementations, the oxygen storage level can be referred to as the fractional oxygen capacity.

In some embodiments, the net reaction rates (r₁, r₂, r₃) are simplified to reduce computation. For example, the backward reaction rate constants k₁^{b} and k₂^{b} can be set to zero, because of the slow kinetics of these backward reactions under conditions of practical interest (e.g., within the range of expected exhaust mass flow rates, exhaust pressures, exhaust temperatures, catalyst temperatures, etc.).

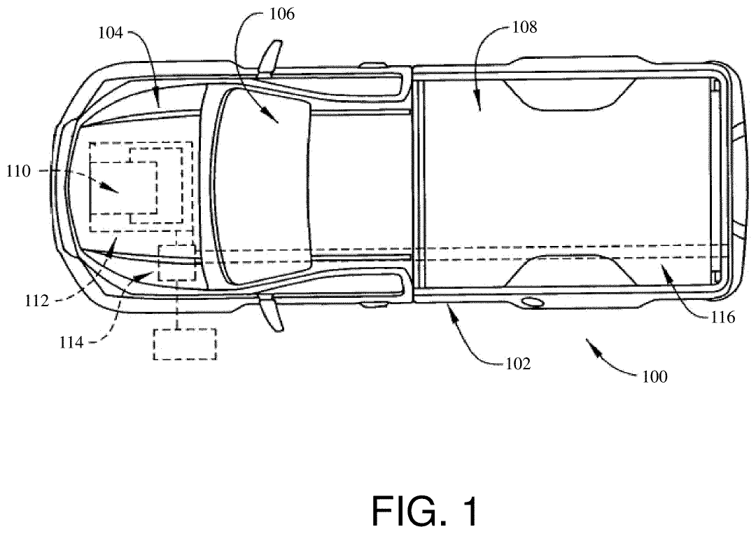

A motor vehicle, in accordance with an aspect of an exemplary embodiment, is indicated generally as 100 in FIG. 1. In particular, the motor vehicle 100 is shown as a pickup truck. It is to be understood, however, that the motor vehicle 100 may take on various forms including automobiles, commercial transports, marine vehicles, and the like. FIG. 1 is a vehicle schematic showing the components of the motor vehicle 100 of interest with the respect to the disclosed principles and the manner in which the components may be interrelated to execute those principles. It will be appreciated, however, that the illustrated architecture is merely an example, and that the disclosed principles do not require that the motor vehicle 100 be configured precisely as shown.

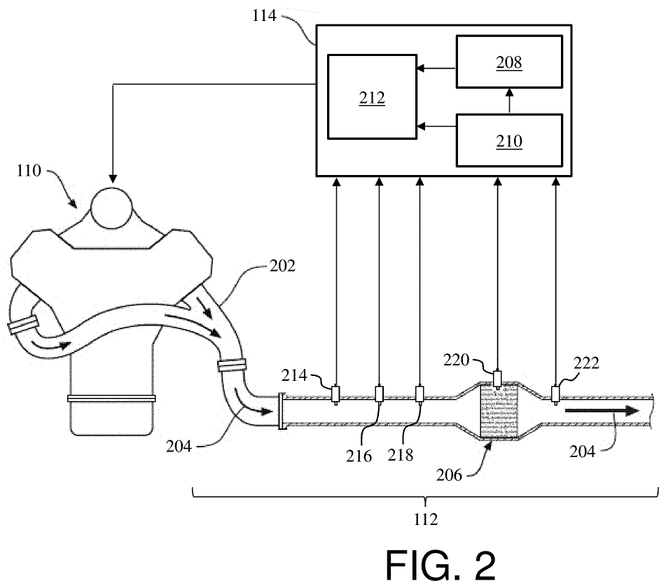

In some embodiments, the motor vehicle 100 includes a body 102 having an engine compartment 104, a passenger compartment 106, and a cargo bed 108. The engine compartment 104 houses an internal combustion engine (ICE) system 110, which, in the exemplary embodiment shown, may include a gasoline engine. The internal combustion engine system 110 includes an exhaust system 112 that is fluidically connected to an aftertreatment or emissions control system 114. Exhaust produced by internal combustion engine system 110 passes through emissions control system 114 to reduce emissions that may exit to ambient through an exhaust outlet pipe 116. In some embodiments, the emissions control system 114 includes a three-reaction oxygen storage model (as depicted in FIG. 2). The three-reaction oxygen storage model can provide an improved OSL estimation to the emissions control system 114 according to one or more embodiments.

It should be noted that technical solutions described herein are germane to ICE systems that can include, but are not limited to, conventional gasoline engine systems and lean burn gasoline systems. The ICE system 110 can include a plurality of reciprocating pistons attached to a crankshaft, which may be operably attached to a driveline, such as a vehicle driveline, to power a vehicle (e.g., deliver tractive torque to the driveline). For example, the ICE system 110 can be any engine configuration or application, including various vehicular applications (e.g., automotive, marine and the like), as well as various non-vehicular applications (e.g., pumps, generators and the like). While the ICEs may be described in a vehicular context (e.g., generating torque), other non-vehicular applications are within the scope of this disclosure. Therefore, when reference is made to a vehicle, such disclosure should be interpreted as applicable to any application of an ICE system.

Moreover, an ICE can generally represent any device capable of generating an exhaust gas stream comprising gaseous (e.g., NOₓ, O₂), carbonaceous, and/or particulate matter species, and the disclosure herein should accordingly be interpreted as applicable to all such devices. As used herein, “exhaust gas” refers to any mixture of chemical species which may require treatment, and includes gaseous, liquid, and solid species. For example, an exhaust gas stream may contain a mixture of one or more NOₓ species, one or more gaseous/liquid hydrocarbon species, and one more solid particulate species (e.g., soot, ash). It should be further understood that the embodiments disclosed herein may be applicable to treatment of effluent streams not comprising carbonaceous and/or particulate matter species, and, in such instances, ICE system 110 can also generally represent any device capable of generating an effluent stream comprising such species. Exhaust gas particulate matter generally includes carbonaceous soot, and other solid and/or liquid carbon-containing species which are germane to ICE exhaust gas or form within an emissions control system 114.

FIG. 2 illustrates example components of the exhaust system 112 and the emissions control system 114 according to one or more embodiments. It should be noted that while the ICE system 110 includes a gasoline engine in the above example, the emissions control system 114 described herein can be implemented in various engine systems, more particularly, any internal combustion engine.

The exhaust system 112 can include an exhaust gas conduit 202, which may comprise several segments, for transporting exhaust gas 204 from the ICE system 110 (e.g., a gasoline engine) to the various exhaust treatment devices of the emissions control system 114. For example, as illustrated, the emission control system 114 includes a three-way catalyst (TWC) 206. In some embodiments, the emission control system 114 also includes one or more heating elements, and/or one or more exhaust particulate filter devices (not depicted).

In some embodiments the exhaust gas 204 exiting the ICE system 110 is directed to the three-way catalyst 206. As can be appreciated, the three-way catalyst 206 can be one of various flow-through catalyst devices capable of oxidizing CO and HCs as well as reducing NOx. In some embodiments, the three-way catalyst 206 may include a flow-through metal or ceramic monolith substrate. The substrate may be packaged in a stainless steel shell or canister having an inlet and an outlet cone in fluid communication with the exhaust gas conduit 202. The substrate can include a catalyst compound disposed thereon. The catalyst compound may be applied as a washcoat and may contain platinum group metals such as platinum (Pt), palladium (Pd), rhodium (Rh) or other suitable oxidizing catalysts, or combination thereof. As discussed previously herein, the three-way catalyst 206 is useful in treating unburned gaseous and non-volatile HC and CO, which are oxidized to form carbon dioxide and water. A washcoat layer includes a compositionally distinct layer of material disposed on the surface of the monolithic substrate or an underlying washcoat layer. A catalyst can contain one or more washcoat layers, and each washcoat layer can have unique chemical catalytic functions. In the three-way catalyst 206, the catalyst compositions for the oxidation and reduction functions can reside in discrete washcoat layers on the substrate or, alternatively, the compositions for the oxidation and reduction functions can reside in discrete longitudinal zones on the substrate.

In some embodiments, the emissions control system 114 can include a catalyst thermal model 208, a three-reaction oxygen storage model 210, and a controller 212. The catalyst thermal model 208 describes the time variation of the exhaust gas temperature and the catalyst temperature which affects the oxygen storage behavior. As discussed previously herein, the oxygen storage model 210 describes the current oxygen storage level Φ in terms of the reversible cerium oxidation rate by oxygen (R1), the reversible cerium reduction rate by carbon monoxide (R2), and the reduction of cerium oxides by hydrogen as well as the re-oxidation of the reduced cerium by water (R3). The catalyst thermal model 208 and the oxygen storage model 210 each comprises a system of partial differential equations (PDEs) which are non-linear and highly coupled. The inputs to the catalyst thermal model 208 and the oxygen storage model 210 include the upstream EQR (EQR=1/λ), the exhaust gas mass flow rate, the exhaust gas pressure, the exhaust gas temperature, and the ambient temperature. The upstream EQR is calculated as 1/λ, and λ can be directly measured using, for example, a wide range air/fuel sensor (WRAF, not depicted).

In some embodiments, the emissions control system 114 is equipped with one or more sensors for monitoring the exhaust system 112. In some embodiments, the one or more sensors include an air/fuel (A/F) sensor 214. The A/F sensor 214 measures the upstream (pre-catalyst) EQR (indirectly measured as 1/λ). The A/F sensor 214 is in fluid communication with the exhaust gas 204 in the exhaust gas conduit 202. The A/F sensor 214 detects the air-to-fuel ratio of the exhaust gas 204 proximate its location and generates A/F signals, which correspond to the air-to-fuel ratios measured. In some embodiments, an EQR signal generated by the A/F sensor 214 can be transmitted to the emissions control system 114, and can be interpreted by the controller 212 as needed for operation of the emission control system 114 and/or the ICE system 110.

In some embodiments, the one or more sensors include one or more exhaust temperature sensors 216. Each of the temperature sensors 216 are in fluid communication with exhaust gas 204 in the exhaust gas conduit 202. The temperature sensors 216 detect temperatures proximate their locations and generate temperature signals, which correspond to the temperatures measured. In some embodiments, a temperature signal generated by a temperature sensor can be transmitted to the emissions control system 114, and can be interpreted by the controller 212 as needed for operation of the emission control system 114 and/or the ICE system 110.

In some embodiments, the one or more sensors include one or more exhaust pressure sensor 218 (e.g., a delta pressure sensor). The exhaust pressure sensors 218 may determine the pressure differential (i.e., Δp) exiting the ICE system 110, or across the TWC 206, depending on the configuration of the emission control system 114 and the placement of the exhaust pressure sensors 218. For example, a first pressure sensor (not shown) may be disposed at the inlet of the TWC 206 and a second pressure sensor (also not shown) may be disposed at the outlet of the TWC 206. Accordingly, the difference between the pressure detected by the second pressure sensor and the pressure detected by the first pressure sensor may indicate the pressure differential across the TWC 206. Alternatively, or in addition, a pressure sensor can be located upstream of the TWC 206 to measure the exhaust pressure leaving the ICE system 110.

In some embodiments, the one or more sensors include a catalyst temperature sensor 220. The catalyst temperature sensor 220 can measure the actual catalyst temperature at a predetermined point (e.g., mid-brick) along the TWC 206.

In some embodiments, the one or more sensors include a wide range air/fuel (WRAF) sensor 222. The WRAF sensor 222 measures the upstream (pre-catalyst) or downstream (post-catalyst) oxygen concentration [O₂]. For example, as depicted, the WRAF sensor 222 measures the post-catalyst air-to-fuel ratio (A/F ratio). In some embodiments, the WRAF sensor 222 is instead positioned upstream of the TWC 206. The WRAF sensor 222 is in fluid communication with the exhaust gas 204 in the exhaust gas conduit 202. The WRAF sensor 222 detects the A/F ratio in the exhaust gas 204 proximate its location and generates [O₂] signals, which correspond to the oxygen concentration [O₂] measured. In some embodiments, an [O₂] signal generated by the WRAF sensor 222 can be transmitted to the emissions control system 114, and can be interpreted by the controller 212 as needed for operation of the emission control system 114 and/or the ICE system 110.

It should be noted that the one or more sensors 214, 216, 218, 220, and 222 are merely exemplary, and that the emissions control system 114 can include different, additional, or fewer sensors than those illustrated/described herein. For example, the emissions control system 114 can further include various flow rate sensors, such as NOₓ sensors, or any other type of sensor that measures one or more parameters of the exhaust gas 204 and/or other components in the motor vehicle 100 (e.g., ambient temperature or pressure sensors, etc.). Other possible sensors include additional pressure sensors, flow rate sensors, particulate matter sensors, and the like. It should be further noted that the block depicting the sensors 214, 216, 218, 220, and 222 is illustrative and that the sensors 214, 216, 218, 220, and 222 can be located at various positions in the motor vehicle 100, such as at an inlet of a device, an outlet of a device, inside a device, and the like. In other words, the various sensors need not be precisely located as depicted for ease of illustration. For example, the sensor 218 can be located upstream of the sensor 214, the sensor 222 can be located prior to, or after, the TWC 206, etc.

In some embodiments, the oxygen storage model 210 receives the exhaust gas mass flow rate and the exhaust gas temperature, and outputs an OSL value. In some embodiments, the oxygen storage model 210 or the emissions control system 114 computes or otherwise determines an oxygen storage level Φ according to the formula:

$$\frac{\partial Φ}{\partial t} = \frac{1}{OSC} \cdot ( 2 {r}_{1} - {r}_{2} - {r}_{3} )$$

In some embodiments, the oxygen storage model 210 provides the oxygen storage level Φ to the controller 212. The controller 212 can be an electronic control unit (ECU) or any other type of processing circuit that includes one or more processors, a memory, and the like for executing one or more computer programming instructions.

In some embodiments, the controller 212 monitors the OSL or Φ determined from the oxygen storage model 210. Based on the measurements, the controller 212 can send one or more control instructions to one or more components of the motor vehicle 100, such as the ICE system 110, and the like. In some embodiments, the controller 212 can be coupled with the one or more components of the motor vehicle 100 using a vehicle communication network, such as a controller area network (CAN) in a wired or wireless manner. For example, the controller 212 can send control instructions to the ICE system 110 (e.g., a gasoline engine) to cause a change in the operation of the engine, which in turn changes a temperature of the engine, the exhaust system 112, and/or the exhaust gas 204.

By monitoring the real-time OSL value determined using the oxygen storage model 210, the controller 212 of the emission control system 114 can accurately adjust the operation of the engine to prevent fueling overshoots (or undershoots), thereby maintaining a stoichiometrically balanced air-to-fuel ratio during actual vehicle operation. The controller 212 can, for example, adjust a fuel injection timing, an amount of air-fuel mixture injected, an idle speed, an exhaust gas recirculation (EGR) rate, a turbo charger air intake, and other such parameters of the operation of the engine.

As can be appreciated from the addition of the third reversible reaction (R3), the three-reaction oxygen storage model 210 must now consider the hydrogen concentration [H₂]. In some embodiments, the hydrogen concentration [H₂] can be directly measured, using, for example, a mass spectrometer placed in the exhaust stream (not depicted). In some embodiments, the hydrogen concentration [H₂] is determined from an engine-out [CO] to [H₂] correlation. In some embodiments, the correlation describes the CO/H₂ concentration ratio as a function of the measured equivalence ratio (EQR, equal to 1/λ).

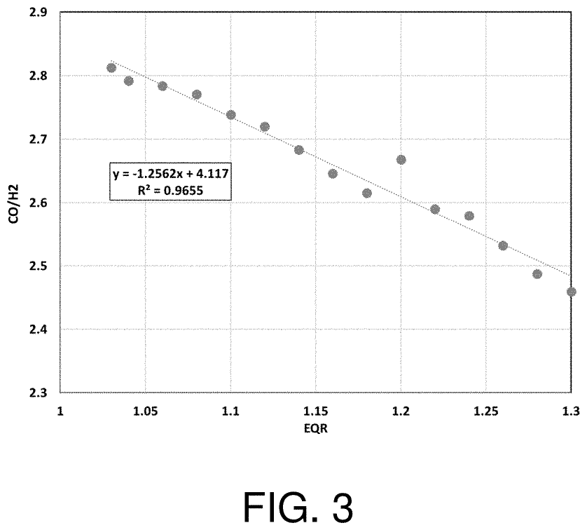

The CO-to-H₂ concentration ratio as a function of measured EQR itself can change depending on the specific engine and operating conditions (e.g., engine type, engine speed, pedal depression percent, air flow). For example, an exemplary CO-to-H₂ concentration ratio curve over a range of EQR values for an engine running at 3350 RPM, a 40% pedal depression, and 50.0 g/s air flow is depicted in FIG. 3. In some embodiments, a lookup table of CO-to-H₂ ratios can be generated for a specific engine under a wide range of operating conditions. For example, additional CO-to-H₂ concentration ratio curves can be determined for different combinations of engine RPM, pedal depressions, and air flow. The data from these additional curves can be added to the lookup table. This process can be repeated for any number of operating conditions to build a robust table capable of handling a wide range and combination of engine speed, pedal depression percent, and air flow.

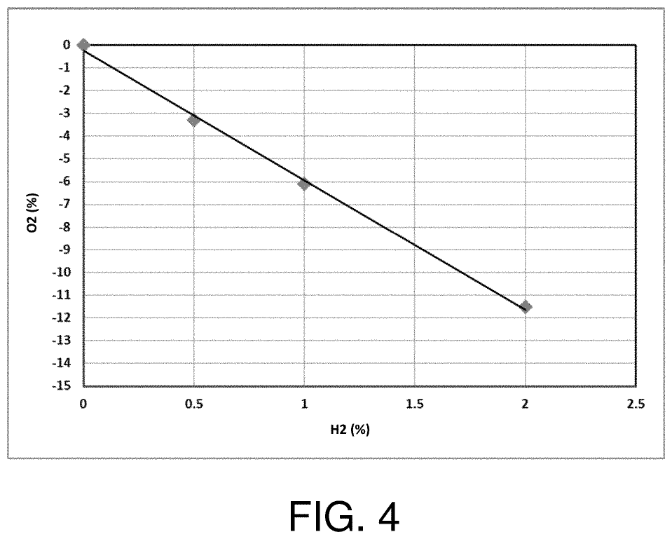

In some embodiments, the emission control system 114 accounts for hydrogen-induced variations in an oxygen sensor reading. For example, an output of the oxygen sensor 222 depicted in FIG. 2 can be adjusted based on the hydrogen concentration [H₂]. In some embodiments, an oxygen sensor reading variation percent can be determined as a function of the hydrogen concentration. For example, an exemplary oxygen sensor reading variation curve over a range of hydrogen concentration values is depicted in FIG. 4. In some embodiments, a lookup table can be generated based off the one or more oxygen sensor reading variation curves. In this manner, the emission control system 114 can quickly adjust (fine-tune) a measured oxygen sensor reading based on the exhaust gas hydrogen concentration.

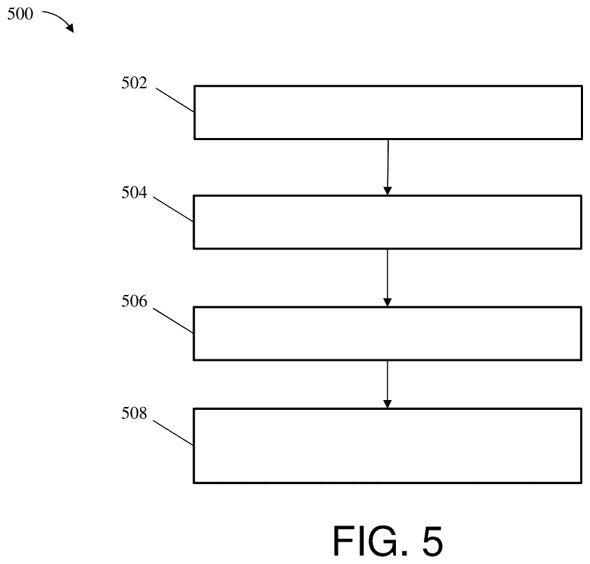

FIG. 5 depicts a flow diagram 500 illustrating a method for treating exhaust gas from an internal combustion engine in a motor vehicle according to one or more embodiments. As shown at block 502, a first reaction rate is determined. The first reaction rate is associated with a reversible cerium oxidation by oxygen. In some embodiments, the first reaction rate is determined according to the formula (r₁) described previously herein.

As shown at block 504, a second reaction rate is determined. The second reaction rate is associated with a reversible cerium oxide reduction by carbon monoxide. In some embodiments, the second reaction rate is determined according to the formula (r₂) described previously herein.

As shown at block 506, a third reaction rate is determined. The third reaction rate is associated with a reduction of cerium oxide by hydrogen and the re-oxidation of the reduced cerium by water. In some embodiments, the third reaction rate is determined according to the formula (r₃) described previously herein.

As shown at block 508, an oxygen storage level is determined based on the first reaction rate, the second reaction rate, and the third reaction rate. In some embodiments, the oxygen storage level is determined according to the formula:

$$\frac{\partial Φ}{\partial t} = \frac{1}{OSC} \cdot ( 2 {r}_{1} - {r}_{2} - {r}_{3} )$$

The technical methods described herein facilitate improvements to emissions control systems used in combustion engines, such as those used in vehicles. The technical features described herein improve the conventional emissions control system by providing a control scheme based on a three-reaction oxygen storage model. Advantageously, the three-reaction oxygen storage model reduces fueling overshoots, improves fuel economy, and lowers emissions.

In terms of hardware architecture, the emissions control system can be implemented in part using a computing device that can include a processor, memory, and one or more input and/or output (I/O) device interface(s) that are communicatively coupled via a local interface. The local interface can include, for example but not limited to, one or more buses and/or other wired or wireless connections. The local interface may have additional elements, which are omitted for simplicity, such as controllers, buffers (caches), drivers, repeaters, and receivers to enable communications. Further, the local interface may include address, control, and/or data connections to enable appropriate communications among the aforementioned components.

When the computing device is in operation, the processor can be configured to execute software stored within the memory, to communicate data to and from the memory, and to generally control operations of the computing device pursuant to the software. Software in memory, in whole or in part, is read by the processor, perhaps buffered within the processor, and then executed. The processor may be a hardware device for executing software, particularly software stored in memory. The processor can be a custom made or commercially available processor, a central processing unit (CPU), an auxiliary processor among several processors associated with the computing device, a semiconductor based microprocessor (in the form of a microchip or chip set), or generally any device for executing software.

The memory can include any one or combination of volatile memory elements (e.g., random access memory (RAM, such as DRAM, SRAM, SDRAM, VRAM, etc.)) and/or nonvolatile memory elements (e.g., ROM, hard drive, CD-ROM, etc.). Moreover, the memory may incorporate electronic, magnetic, optical, and/or other types of storage media. Note that the memory can also have a distributed architecture, where various components are situated remotely from one another, but can be accessed by the processor.

The software in the memory may include one or more separate programs, each of which includes an ordered listing of executable instructions for implementing logical functions. A system component embodied as software may also be construed as a source program, executable program (object code), script, or any other entity comprising a set of instructions to be performed. When constructed as a source program, the program is translated via a compiler, assembler, interpreter, or the like, which may or may not be included within the memory.

One should note that FIG. 5 shows an architecture, functionality, and/or operation scheme that can be implemented in part using software. In this regard, one or more of the blocks can be interpreted to represent a module, segment, or portion of code, which comprises one or more executable instructions for implementing the specified logical function(s). It should also be noted that in some alternative implementations, the functions noted in the blocks may occur out of the order and/or not at all. For example, two blocks shown in succession may in fact be executed substantially concurrently or the blocks may sometimes be executed in the reverse order, depending upon the functionality involved.

One should note that any of the functionality described herein can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” contains, stores, communicates, propagates and/or transports the program for use by or in connection with the instruction execution system, apparatus, or device. The computer readable medium can be, for example but not limited to, an electronic, magnetic, optical, electromagnetic, infrared, or semiconductor system, apparatus, or device. More specific examples (a non-exhaustive list) of a computer-readable medium include a portable computer diskette (magnetic), a random access memory (RAM) (electronic), a read-only memory (ROM) (electronic), an erasable programmable read-only memory (EPROM or Flash memory) (electronic), and a portable compact disc read-only memory (CDROM) (optical).

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof

While the above disclosure has been described with reference to illustrative embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. An emissions control system for treating exhaust gas from an internal combustion engine in a motor vehicle, the emissions control system comprising:
a three-way catalyst;
a three-reaction oxygen storage model; and
a controller operably connected to the three-reaction oxygen storage model, the controller configured to execute a method for controlling an oxygen storage level for the three-way catalyst, the method comprising:
determining a first reaction rate representing a net rate of cerium oxidation by oxygen;
determining a second reaction rate representing a net rate of cerium reduction by carbon monoxide;
determining a third reaction rate representing a net rate of cerium reduction by hydrogen; and
determining the oxygen storage level based on the first reaction rate, the second reaction rate, and the third reaction rate.

2. The emissions control system of claim 1, wherein the controller is further configured to adjust an operation of the internal combustion engine in response to the determined oxygen storage level.

3. The emissions control system of claim 2, wherein adjusting the operation of the internal combustion engine comprises adjusting the timing and amount of fuel injection, an engine speed, or an air intake.

4. The emissions control system of claim 1, further comprising:
an air/fuel (A/F) sensor positioned upstream of the three-way catalyst; and
wherein the controller is further configured to receive a measured air-to-fuel ratio from the A/F sensor.

5. The emissions control system of claim 1, wherein the three-reaction oxygen storage model comprises:
a first reaction according to the formula:
O₂+2 Ce₂O₃ [symbol] 2 Ce₂O₄;
a second reaction according to the formula:
CO+Ce₂O₄ [symbol] CO₂+Ce₂O; and
a third reaction according to the formula:
H₂+Ce₂O₄ [symbol] H₂O+Ce₂O₃.

6. The emissions control system of claim 5, further comprising, determining the oxygen storage according to the formula:
$$\frac{\partial Φ}{\partial t} = \frac{1}{OSC} \cdot ( 2 {r}_{1} - {r}_{2} - {r}_{3} ) .$$

7. The emissions control system of claim 1, further comprising:
a wide range air/fuel (WRAF) sensor operably coupled to the controller; and
wherein the controller is further configured to receive a measured air-to-fuel ratio from the WRAF sensor.

8. The emissions control system of claim 7, wherein the controller is further configured to account for a hydrogen-induced WRAF sensor reading variation.

9. A method for treating exhaust gas from an internal combustion engine in a motor vehicle, the method comprising:
providing an oxygen storage model, the oxygen storage model comprising a first reaction associated with a net rate of cerium oxidation by oxygen, a second reaction associated with a net rate of cerium reduction by carbon monoxide, and a third reaction associated with a net rate of cerium reduction by hydrogen;
determining a first reaction rate associated with the first reaction;
determining a second reaction rate associated with the second reaction;
determining a third reaction rate associated with the third reaction; and
determining an oxygen storage level of the three-way catalyst based on the first reaction rate, the second reaction rate, and the third reaction rate.

10. The method of claim 9, further comprising adjusting an operation of the internal combustion engine in response to the determined oxygen storage level.

11. The method of claim 10, wherein adjusting the operation of the internal combustion engine comprises adjusting a fuel injection timing, an injected amount of air-fuel mixture, an engine speed, or an air intake.

12. The method of claim 9, further comprising receiving a measured air-to-fuel ratio from an air/fuel (A/F) sensor positioned upstream of the three-way catalyst.

13. The method of claim 9, wherein the first reaction comprises:
O₂+2 Ce₂O₃ [symbol] 2 Ce₂O₄;
the second reaction comprises:
CO+Ce₂O₄ [symbol] CO₂+Ce₂O; and
the third reaction comprises:
H₂+Ce₂O₄ [symbol] H₂O+Ce₂O₃.

14. The method of claim 9, further comprising determining the oxygen storage according to the formula:
$$\frac{\partial Φ}{\partial t} = \frac{1}{OSC} \cdot ( 2 {r}_{1} - {r}_{2} - {r}_{3} ) .$$

15. The method of claim 9, further comprising receiving a measured air-to-fuel ratio from a wide range air/fuel (WRAF) sensor.

16. The method of claim 15, further comprising adjusting the measured air-to-fuel ratio based on a hydrogen concentration.

17. A computer program product comprising a memory storage device having computer executable instructions stored therein, the computer executable instructions when executed by a processor causes the processor to execute a computer-implemented method for treating exhaust gas from an internal combustion engine in a motor vehicle, the method comprising:
providing an oxygen storage model, the oxygen storage model comprising a first reaction associated with a net rate of cerium oxidation by oxygen, a second reaction associated with a net rate of cerium reduction by carbon monoxide, and a third reaction associated with a net rate of cerium reduction by hydrogen;
determining a first reaction rate associated with the first reaction;
determining a second reaction rate associated with the second reaction;
determining a third reaction rate associated with the third reaction; and
determining an oxygen storage level of the three-way catalyst based on the first reaction rate, the second reaction rate, and the third reaction rate.

18. The computer program product of claim 17, further comprising adjusting an operation of the internal combustion engine in response to the determined oxygen storage level.

19. The computer program product of claim 17, wherein adjusting the operation of the internal combustion engine comprises adjusting the timing and amount of fuel injection, an engine speed, or an air intake.

20. The computer program product of claim 17, further comprising:
receiving a measured air-to-fuel ratio from a wide range air/fuel (WRAF) sensor; and
adjusting the measured air-to-fuel ratio based on a hydrogen concentration.
